(19) United States
(12) Patent Application Publication
(10) Pub. No.: US 2015/0030998 A1
(43) Pub. Date: Jan. 29, 2015

(54) Method and Apparatus for Automated Vehicle Support

(71) Applicant: Ford Global Technologies, LLC, Dearborn, MI (US)

(72) Inventors: Yimin Liu, Ann Arbor, MI (US); Oleg Yurievitch Gusikhin, West Bloomfield, MI (US); Perry Robinson MacNeille, Lathrup Village, MI (US); James Arthur Buczkowski, Troy, MI (US); Alfredo Cateriano, Novi, MI (US)

(73) Assignee: Ford Global Technologies, LLC, Dearborn, MI (US)

(21) Appl. No.: 13/951,610

(22) Filed: Jul. 26, 2013

(51) Int. Cl. G09B 5/02; B60R 99/00

(52) U.S. Cl. CPC G09B 5/02; B60R 99/00
USPC 434/62

(57) ABSTRACT

A system includes a processor configured to detect the presence of a driver in a vehicle. The processor is further configured to determine a demonstration of a vehicle feature appropriate for the driver and offer demonstration of the vehicle feature. The processor is also configured to provide a demonstration of the vehicle feature, upon acceptance of the offer.

### TECHNICAL FIELD

The illustrative embodiments generally relate to a method and apparatus for an automated vehicle support.

### BACKGROUND

Many people buy sophisticated computers, digital cameras, advanced automobiles, versatile cell phones and other complicated technology. Following these purchases, buyers will often forget, decline or flat-out refuse to read instructions. Most people don't like to use manuals, especially when modern manuals are often packed with information that will rarely, if ever, be used. Only about one out of five people read a full manual or instructions for purchased items. In the United States, approximately ninety-five percent of all returned technological products actually work, despite what the returner may think.

Many calls to help-lines and customer frustration can be avoided by reading a manual, which often contains the answer to the question plaguing the consumer. Manuals can also be lost or misplaced, or may not come with second-hand goods.

Manuals are being designed with convenience and ease in mind, to encourage use by providing the most seamless experience possible for a customer. Consumers want something that comes out of the box that can simply be used immediately. Consumers want features to be intuitive, simple to use without resorting to instruction reading. As the complexity of gadgets increases, however, and thus the size of the corresponding manuals does too, consumers are unfortunately even more incentivized to skip the manuals.

U.S. Application 2005/0108249 generally relates to a method of delivering vehicle owner's manual or other vehicle-specific information to the vehicle operator from a remote data center and associated vehicle information database by utilizing a voice recognition system at the remote data center and delivering the information to the vehicle operator in audible speech. The vehicle operator speaks his request in the vehicle and the data center recognizes the request, perhaps asks more questions, leads the vehicle operator through a spoken menu, and then provides the answer vocally to the vehicle operator over the speaker(s) located in the vehicle. The disclosure includes methodology for obtaining vehicle diagnostic information and controlling certain vehicle functions automatically via an embedded telematics control unit. The invention further includes remote telephone access outside the vehicle.

W.O. 2009/138131 generally relates to a system adapted to be incorporated in a vehicle dashboard. The system includes at least one instrument board for providing information regarding the operation of the vehicle based on vehicle operative parameters measured and provided by a plurality of measuring units each one measuring at least one respective vehicle operative parameter. The system further includes a main programmable data processing unit coupled to the measuring units for collecting operative signals indicative of the measured operative parameters. The at least one instrument board includes at least one graphical display unit controlled by the main programmable data processing unit, the graphical display unit being adapted to display graphical images according to video signals generated and provided thereto by the main programmable data processing unit based on the collected operative signals.

### SUMMARY

In a first illustrative embodiment, a system includes a processor configured to detect the presence of a driver in a vehicle. The processor is further configured to determine a demonstration of a vehicle feature appropriate for the driver and offer demonstration of the vehicle feature. The processor is also configured to provide a demonstration of the vehicle feature, upon acceptance of the offer.

In a second illustrative embodiment, a computer-implemented method includes detecting the presence of a driver in a vehicle. The method also includes determining a demonstration of a vehicle feature appropriate for the driver. The method further includes offering demonstration of the vehicle feature and, upon acceptance of the offer, providing a demonstration of the vehicle feature.

In a third illustrative embodiment, a non-transitory computer readable storage medium stores instructions that, when executed by a processor, cause the processor to perform a method including detecting the presence of a driver in a vehicle. The method also includes determining a demonstration of a vehicle feature appropriate for the driver. The method further includes offering demonstration of the vehicle feature and, upon acceptance of the offer, providing a demonstration of the vehicle feature.

### BRIEF DESCRIPTION OF THE DRAWINGS

FIG. 1 shows an illustrative vehicle computing system;

FIG. 2 shows an illustrative example of a demo presentation process;

FIG. 3 shows an illustrative example of an automatic demo process;

FIG. 4 shows an illustrative example of another automatic demo process; and

FIG. 5 shows an illustrative example of a third automatic demo process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

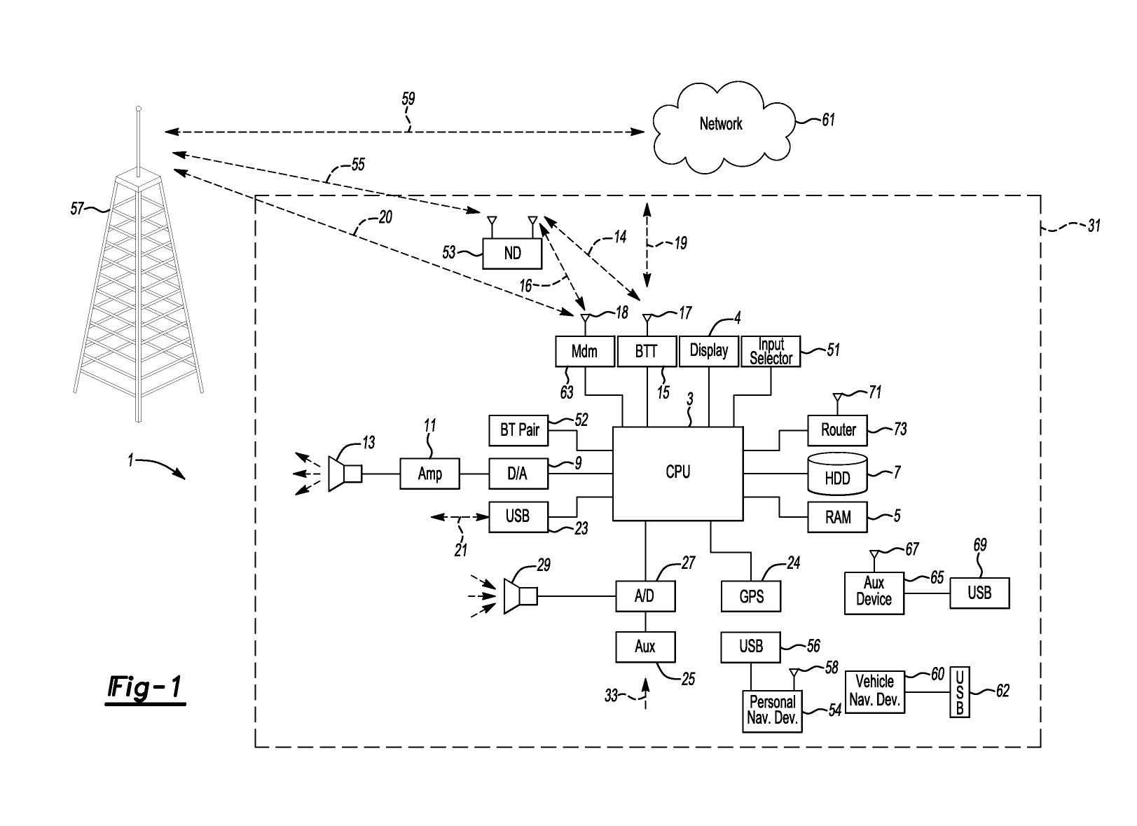

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a universal serial bus (USB) input 23, a global positioning system (GPS) input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a controller area network (CAN) bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as personal navigation device (PND) 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, personal digital assistant (PDA), or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the central processing unit (CPU) is instructed that the onboard BLUETOOTH transceiver will be paired with a BLUETOOTH transceiver in a nomadic device.

Data may be communicated between CPU 3 and network 61 utilizing, for example, a data-plan, data over voice, or dual-tone multi-frequency (DTMF) tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as infrared data association (IrDA)) and non-standardized consumer infrared (IR) protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domian Multiple Access (CDMA), Time Domain Multiple Access (TDMA), Space-Domian Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself One of ordinary skill in the art will understand when it is inappropriate to apply a particular VACS to a given solution. In all solutions, it is contemplated that at least the vehicle computing system (VCS) located within the vehicle itself is capable of performing the exemplary processes.

Many vehicle purchasers still go to dealers for vehicle purchasing, and many automotive original equipment manufacturers (OEMs) encourage dealers to offer owner orientation clinics. Many vehicle quality complaints could be completely avoided if a consumer actually understood how all the vehicle systems worked.

To aid in the education of new consumers, a digital manual is provided that can be accessed through a vehicle interface. This interactive menu system will aid in the education of consumers with regards to new and existing vehicle features. Changes to vehicle options, use of features and addition of features can be transmitted to consumers and education on these options and features can be provided upon request or use. This can help avoid paging through an entire manual.

For example, after a consumer walks into a showroom and takes a test drive, the VCS could automatically start an introduction demonstration with a variety of system demos. Various selected features can be visually and audibly explained. This process can be accessed on driver demand as well, once a vehicle has been purchased. The system can also track which features have been previously examined, which demos have been seen, and where previous demonstrations and lessons have left off.

The digital manual can be stored within a vehicle memory, a mobile device memory, or even on a server for delivery on demand. The manual can also be activated by triggering of vehicle alert states, helping an owner understand the actual meaning of warnings presented while in the vehicle. Seemingly improper use of systems can also be corrected, such as engaging recirculation when the vehicle dew point temperature is similar to that of the glass. Such advice can help a driver properly interact with vehicle systems and improve customer relations and driver appreciation of the vehicle.

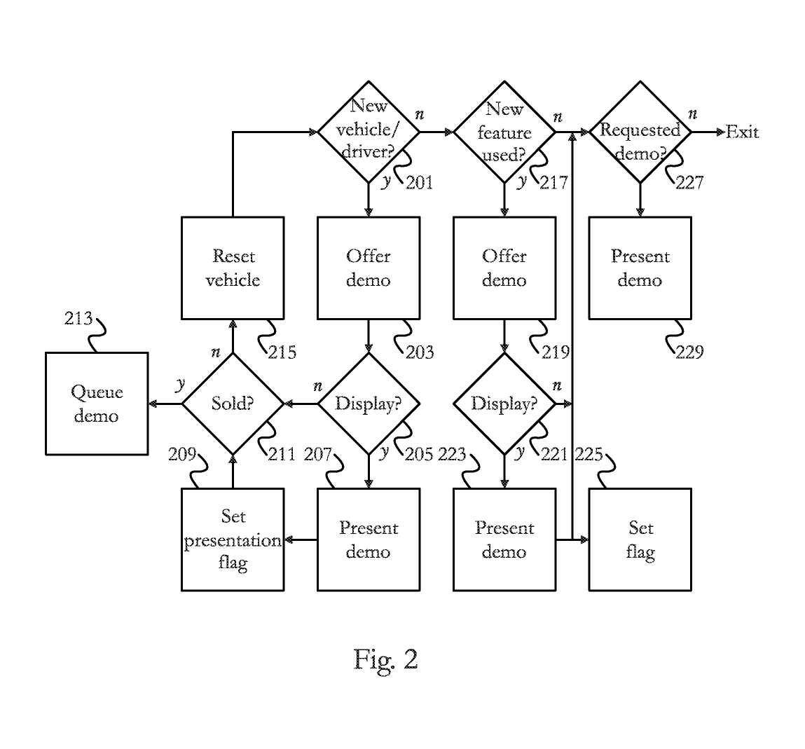

FIG. 2 shows an illustrative example of a demo presentation process. In this illustrative example, the demonstration control process interacts with the VCS to determine a number of factors about vehicle use and ownership. Different drivers, new owners, use of new features and other triggers can cause some portion of the manual or a demonstration process to occur.

In this illustrative example, the process can determine (or interact with a determination module) whether or not a new driver is present in a vehicle. This could be done, for example, without limitation, using a visual recognition system, recognition of a driver/occupant device, or even indicia of a new driver to a vehicle input (e.g., selection of a “new driver” button).

If there is a new driver present 201, the process will offer a demonstration of vehicle features 203. This could be, for example, commonly used features, most commonly misunderstood features, or even a customizable selection of particular features. The customization could be designated by a customer, a user, a dealer, an OEM, etc.

If the demonstration is selected for display 205, the selected or designated demonstration can then be presented via vehicle outputs 207. For example, use of a vehicle display could be implemented to demonstrate features, or, for example, use of vehicle speakers could be implemented to output a demonstration in an audible fashion.

In this example, a presentation flag is set, representing that the demonstration has been run 209. This can be used to track a number of times a demonstration has been used, used in future presentation suggestions (e.g., flags can be set per demonstrated feature) and otherwise used to avoid customer annoyance (e.g., not re-offering previously demonstrated features or demos). Also, since the vehicle may transition from a dealer to a consumer, the process may track if the vehicle has been sold 211. This could be indicated by a dealer or a consumer. It could also be indicated by a new-owner setup process.

If the vehicle has been sold, and if the demonstration currently enabled is a dealer-oriented demonstration, the process can queue the demonstration 213 so that it is not delivered unless specifically requested. This can help avoid re-presentation of the demonstration every time a new owner or family member enters the vehicle. If the vehicle has not been sold, the process may “reset” the vehicle 215. This sets the vehicle for presenting a new feature demo any time that a new potential customer enters the vehicle.

If the same driver who has previously driven the vehicle is present again, the process detects if a new feature of the vehicle is being used 217. If there is no use of a new feature, the demonstration process may be put on hold unless a demonstration is specifically requested 227. If a certain demonstration or feature aid is requested, the process can provide information relating to the requested feature 229.

If a new feature (e.g., without limitation, a navigation feature) is being used, the process may offer a demonstration or video related to the new feature 219. This could be an interactive demonstration, or simply a series of instructions. In any event, the process will help the user better understand the new feature so that any confusion or frustration could be avoided. If the user elects to view/use the demonstration 221, the process can present the demonstration 223. Also, in this example, a flag relating to the feature or demonstration can be set, so that the system does not attempt to offer the demo in the future unless the demo is requested.

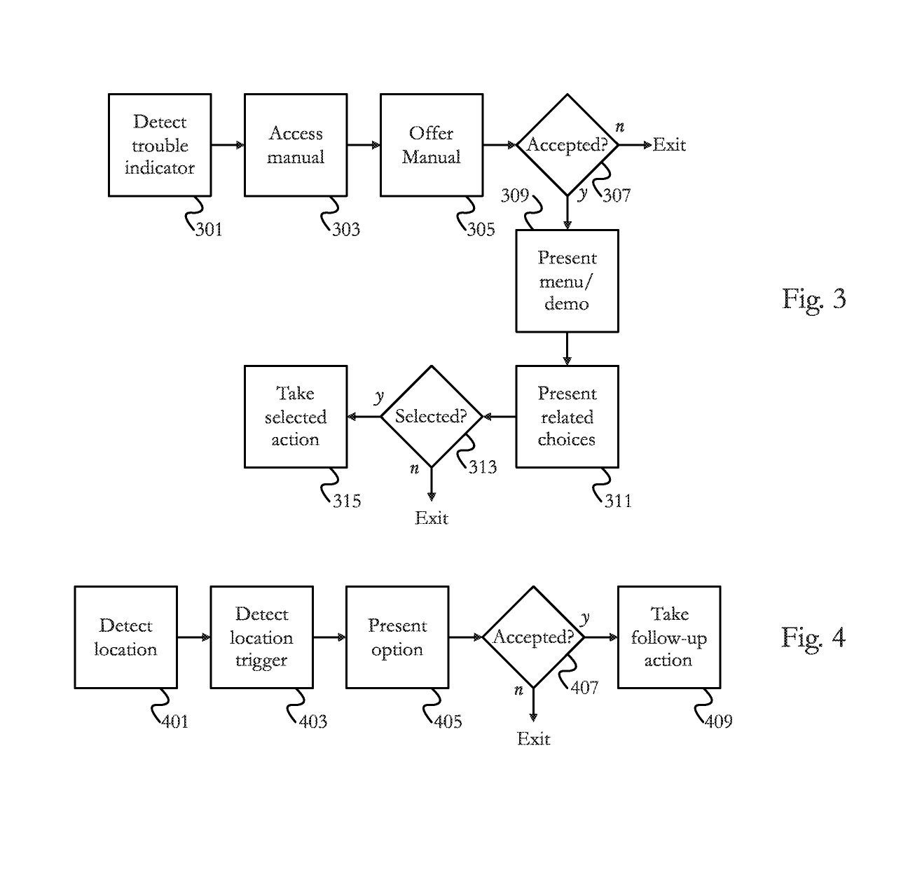

FIG. 3 shows an illustrative example of an automatic demo process. In this illustrative example, a manual or demonstration process can be engaged when a trouble indicator, such as a system light or other system problem is detected. This can help a consumer better understand both the cause and meaning of the indicator, and help avoid unneeded trips to a mechanic and/or customer dissatisfaction.

If a trouble indicator is detected (system message, dashboard light, etc.) 301, the process can access a digital manual 303. This manual could be located locally, on a connected device, or on a remote server. Access to the manual can provide some indicia of which presentation or demonstration should be presented in conjunction with the detected problem. The appropriate content could then be offered to the user 305. The offer to the user could be made in conjunction with a warning signal, in addition to the warning signal, or via an output other than that used to provide the warning signal.

If the user accepts the offer for the demonstration 307, the process may present a pre-configured demonstration/warning video, or the process may present a series of selections or information relating to the trouble 309. The menu could instruct the user to perform one or more steps to better diagnose the problem, or could include instructional options as to how to address the problem. In addition, related options could also be shown 311.

For example, if the warning was for a flat tire, the process could show information on tire deflation, a current tire level, what proper tire levels are. The process may also determine if the tire is likely low on air or flat, based on, for example, a rate or level of deflation. If the tire was simply low on air, the process could provide a “how to fill a tire” demo related to the low air condition. If the tire was likely flat, the process could provide several features such as, but not limited to, “where is the jack/spare located,” “how to change a tire,” and/or “contact a service for assistance.”

If the user selected any of these related actions 313, the process could then provide a secondary demonstration (if appropriate) corresponding to the selected action, or, in some cases, could take an action such as contacting a roadside assistance operator 315. In this manner, user questions about vehicle warning conditions can be easily and quickly addressed, without unnecessarily aggravating the user or contacting a customer service agent.

FIG. 4 shows an illustrative example of another automatic demo process. In this illustrative example, a demonstration or offering may be provided when a vehicle is in a certain location.

For example, if a vehicle needed servicing, or had a recall issued thereon, the process may wish to remind the owner when the owner is near an authorized service location or dealer. Other condition related events might also occur, such as advising a tire inflation if a user is near a gas station.

In this illustrative example, the process detects a location of the vehicle 401 and can use that location as a reference to look up surrounding offerings. The correspondence of a local offering with a vehicle location and vehicle condition could be used as a trigger 403 to provide indicia that a further service should be offered.

The option(s) may be offered to the user at the appropriate time, as determined by the triggering process 405. If the user accepts the offer or suggestion 407, any appropriate follow up action may be taken as needed 409. For example, if the user elects to take the opportunity to have a factory recall issue addressed, the process may contact a selected dealer to let them know the user is en-route. This can help speed things along when the customer arrives at the dealer.

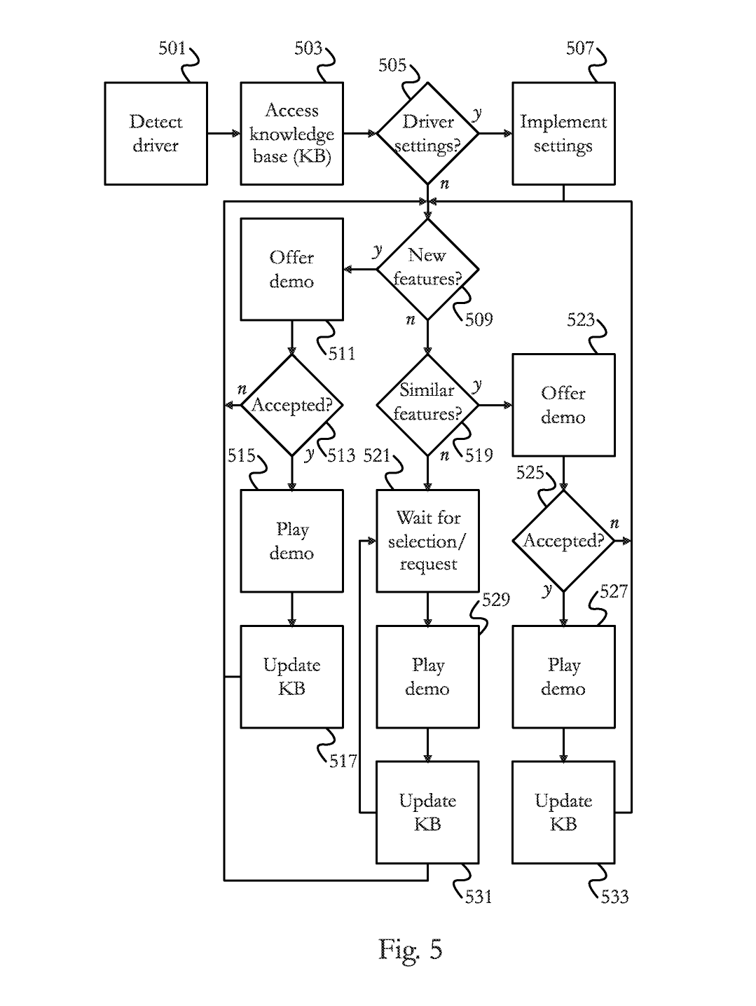

FIG. 5 shows an illustrative example of a third automatic demo process. This is a process that may run at any time that a driver enters a vehicle. Whether or not the vehicle is at dealership or owned, this process may continue unless a demonstration process is disabled. This illustrative process is capable of determining a driver identity 501, through, for example, a connected device identified as corresponding to a driver, a driver login, visual recognition, seat weight sensors or other vehicle sensors, etc.

The process can also access a knowledge base (KB) 503. This could be locally or remotely stored, and contain the useful manual and demonstration information. The KB may also contain information that indicates which features for which demonstrations have been previously viewed. This can aid in driver selection of new feature viewing, so that the driver does not repeatedly get offered the same demonstrations (unless desired).

There may also be one or more driver settings associated with the identified driver 505 (or with the vehicle itself). For example, without limitation, the driver may desire to only view information when a problem occurs, or only view information relating to new or previously unused features, etc. Any such settings can be implemented 507 before offering demonstrations to the driver. If there are new features on the vehicle (updates to the system, newly installed applications or devices, etc.) 509, the process may (if permitted), offer a demonstration relating to these new features 511.

The offered demonstration may be accepted or rejected by the driver 513. If the driver accepts the offer, the process can play a demo related to the new feature 515, showing the driver how the feature works, how to use the feature, common problems encountered, etc. The KB may then be updated to indicate that the driver has viewed a demonstration corresponding to the particular feature 517.

In another embodiment, to encourage, for example, driver exploration of vehicle features, the process may determine if there are similar features to those which a driver has previously explored 519. Additionally or alternatively, the process may determine if there are any unexplored features that could be recommended to the driver. Use of similar features may provide features which a driver is more likely to use, but unexplored features could open up a whole new realm of possibility for driver exploration.

If there are no features that the system determines worthy of recommendation 519, the process may wait for a driver-initiated selection of features or a request for information 521. Any selected or requested feature demonstration can be provided 529 as needed. Also, in this example, the KB is updated to indicate that a particular feature has been demonstrated or requested by a driver 531.

Finally, if there are any similar or otherwise recommended features, a similar selection process may ensue. The driver may be offered a demonstration or information relating to the recommended features 523. This process may result in acceptance of the offered demonstration 525, which can cause the system to present a demonstration corresponding to the feature 527. The KB may then be updated to indicate that the driver has now viewed this demonstration.

For any given demonstration, the driver may be given an option to indicate whether, for example, without limitation, the demonstration should again be recommended at a later time, never offered again, offered only upon specific request, etc. This sort of information can be stored with a driver profile and/or in the KB for reference by future suggestion processes.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
detect the presence of a driver in a vehicle;
determine a demonstration of a vehicle feature appropriate for the driver;
offer demonstration of the vehicle feature; and
upon acceptance of the offer, provide a demonstration of the vehicle feature.

2. The system of claim 1, wherein the processor is further configured to determine a feature which has not yet been utilized as the vehicle feature.

3. The system of claim 1, wherein the processor is further configured to determine a feature related to a feature that has been previously utilized as the vehicle feature.

4. The system of claim 1, wherein the processor is further configured to track which features have had demonstrations provided therefor.

5. The system of claim 1, wherein the processor is further configured to exclude features for which demonstrations have been previously provided in the determination of the vehicle feature.

6. The system of claim 1, wherein the processor is further configured to determine a driver identity.

7. The system of claim 6, wherein the processor is further configured to determine the feature based on which features have been previously presented to an identified driver.

8. A computer-implemented method comprising:
detecting the presence of a driver in a vehicle;
determining a demonstration of a vehicle feature appropriate for the driver;
offering demonstration of the vehicle feature; and
upon acceptance of the offer, providing a demonstration of the vehicle feature.

9. The method of claim 8, further including determining a feature which has not yet been utilized as the vehicle feature.

10. The method of claim 8, further including determining a feature related to a feature that has been previously utilized as the vehicle feature.

11. The method of claim 8, further including tracking which features have had demonstrations provided therefor.

12. The method of claim 8, further including excluding features for which demonstrations have been previously provided in the determination of the vehicle feature.

13. The method of claim 8, further including determining a driver identity.

14. The method of claim 13, further including determining the feature based on which features have been previously presented to an identified driver.

15. A non-transitory computer readable storage medium, storing instructions that, when executed by a processor, cause the processor to perform a method comprising:
detecting the presence of a driver in a vehicle;
determining a demonstration of a vehicle feature appropriate for the driver;
offering demonstration of the vehicle feature; and
upon acceptance of the offer, providing a demonstration of the vehicle feature.

16. The storage medium of claim 15, wherein the method further includes determining a feature which has not yet been utilized as the vehicle feature.

17. The storage medium of claim 15, wherein the method further includes determining a feature related to a feature that has been previously utilized as the vehicle feature.

18. The storage medium of claim 15, wherein the method further includes tracking which features have had demonstrations provided therefor.

19. The storage medium of claim 15, wherein the method further includes excluding features for which demonstrations have been previously provided in the determination of the vehicle feature.

20. The storage medium of claim 15, wherein the method further includes determining a driver identity and determining the feature based on which features have been previously presented to an identified driver.
